(19) United States
(12) Patent Application Publication
(10) Pub. No.: US 2025/0373175 A1
(43) Pub. Date: Dec. 4, 2025

(54) SWITCHED-MODE POWER SUPPLY

(71) Applicant: FUJI ELECTRIC CO., LTD., Kanagawa (JP)

(72) Inventor: Kodai MIYAGI, Matsumoto-city (JP)

(21) Appl. No.: 19/185,097

(22) Filed: Apr. 21, 2025

(30) Foreign Application Priority Data
Jun. 4, 2024 (JP) 2024-090817

(51) Int. Cl. H02M 7/00; H02M 1/32

(52) U.S. Cl. CPC H02M 7/003; H02M 1/32

(57) ABSTRACT

There is provided a switched-mode power supply including a main transformer, a switching device which performs switching control of a main current flowing through the main transformer, a control chip which includes a first terminal and controls the switching device, a first capacitor connected to the first terminal of the control chip, and a first resistor element connected to the first terminal, in which the control chip includes a semiconductor substrate including a first connecting region connected to the first terminal, the first resistor element is arranged between the first connecting region and the first capacitor, and the first terminal is a power supply terminal to which power supply electric power is supplied.

The contents of the following patent application(s) are incorporated herein by reference: NO. 2024-090817 filed in JP on June 4, 2024.

### BACKGROUND

### 1. TECHNICAL FIELD

The present invention relates to a switched-mode power supply.

### 2. RELATED ART

FIG. 1 of Patent Document 1 illustrates "a resistance component connected to a power supply terminal P1 and a voltage VW between both ends of the resistance component, and paragraph 0036 describes "VW is a voltage generated when a surge current IESD flows through a resistance component of a wiring 4". FIG. 1 of Patent Document 2 illustrates a capacitor 35 connected to a VCC terminal of a control IC 32.

Patent Document 1: Japanese Patent Application Publication No. 2017-152462

Patent Document 2: Japanese Patent Application Publication No. 2023-9397

### BRIEF DESCRIPTION OF THE DRAWINGS

FIG. 1 illustrates an example of a switched-mode power supply 300.

FIG. 2 is a diagram for describing an operation example of a control chip 100.

FIG. 3 is a cross sectional view of a semiconductor substrate 10 in the control chip 100.

FIG. 4 illustrates a configuration example of a switched-mode power supply 200 according to an embodiment of the present invention.

FIG. 5 is a diagram for describing the operation example of the control chip 100 illustrated in FIG. 4.

FIG. 6 is a cross sectional view of the semiconductor substrate 10 in the control chip 100 according to a modified example.

FIG. 7 is a cross sectional view of the semiconductor substrate 10 in the control chip 100 according to the modified example.

### DESCRIPTION OF EXEMPLARY EMBODIMENTS

Hereinafter, the present invention will be described by way of embodiments of the invention. However, the following embodiments are not for limiting the invention according to the claims. In addition, not all of the combinations of features described in the embodiments are essential to the solution of the invention. Note that in the present specification and the diagrams, elements having substantially the same function and configuration are denoted with a same reference sign to omit duplicated descriptions, and illustrations of elements that are not directly related to the present invention will be omitted. Furthermore, in one drawing, elements having the same functions and configurations are denoted by a representative reference numeral, and other reference numerals for the elements may be omitted. In the present specification, a case where a term such as "same" or "equal" is mentioned may include a case having an error due to a variation in manufacturing or the like. The error is, for example, within 10%.

In an explanation of a circuit, when it is described that an element C is provided "between" an element A and an element B, it implies that the element C is provided between the element A and the element B in an electrical channel. The above explanation is not for limiting a spatial position of the element C.

When it is described in the present specification that two elements are "electrically connected", it refers to a state in which an electric signal, a voltage, or a current can be transmitted between the two elements. The two elements may be directly connected by a wiring or the like, or another electrical element may be present between the two elements.

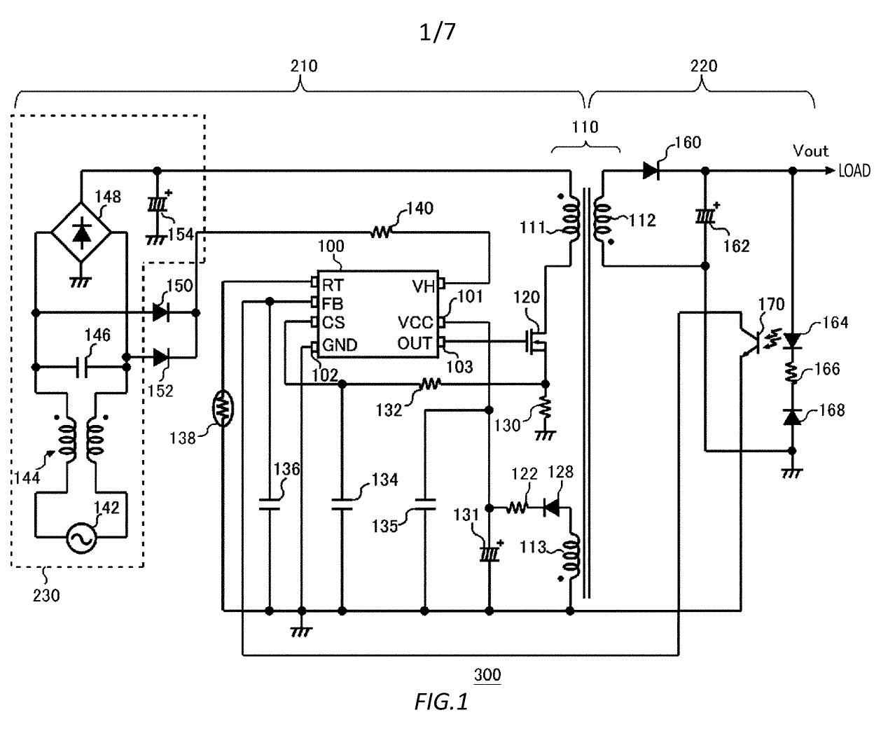

FIG. 1 illustrates an example of a switched-mode power supply 300. By repeatedly controlling a switching device 120 connected to a primary side winding 111 of a main transformer 110 to be put into an ON state and an OFF state, the switched-mode power supply 300 generates a predetermined voltage or current in a secondary side winding 112 of the main transformer. The switched-mode power supply 300 of the present example includes a power supply circuit 230, a primary side circuit 210, a secondary side circuit 220, and the main transformer 110.

The primary side circuit 210 may include a power supply circuit 230. The power supply circuit 230 supplies power supply electric power to the primary side circuit 210. The power supply circuit 230 of the present example includes an AC power supply 142, a coil 144, a capacitor 146, a diode bridge unit 148, a diode 150, a diode 152, and a capacitor 154. The AC power supply 142 may be an external power supply such as a commercial power supply.

The coil 144 is connected to the AC power supply 142. The coil 144 may be provided for both a positive-side output terminal and a negative-side output terminal of the AC power supply 142. The coil 144 may be a transformer connected to the positive-side output terminal and the negative-side output terminal of the AC power supply 142. The capacitor 146 is provided between the positive-side output terminal and the negative-side output terminal of the AC power supply 142. Noise in AC power output by the AC power supply 142 is removed by the coil 144 and the capacitor 146.

The diode bridge unit 148 performs full-wave rectification of the AC power output by the AC power supply 142. The capacitor 154 smoothens electrical power rectified by the diode bridge unit 148. With this configuration, the power supply circuit 230 rectifies and smoothens the voltage and current from the AC power supply 142 to be output.

The primary side circuit 210 of the present example includes a control chip 100, the primary side winding 111, the switching device 120, a resistance 130, an auxiliary winding 113, a diode 128, a second resistor element 122, a first capacitor 131, a second capacitor 135, a capacitor 134, a capacitor 136, a resistance 132, a thermistor 138, and a resistance 140. The primary side winding 111 of the present example is supplied with the power supply electric power from the power supply circuit 230.

The secondary side circuit 220 of the present example includes the secondary side winding 112, a diode 160, a capacitor 162, a light emitting device 164, a resistance 166, and a diode 168. The secondary side winding 112 is magnetically coupled to the primary side winding 111. Note that a light receiving device 170 illustrated in FIG. 1 may be provided in the primary side circuit 210.

The switching device 120 performs switching control of a main current flowing through the main transformer 110. The switching device 120 of the present example is connected to the primary side winding 111 in series and performs switching control as to whether or not the main current is caused to flow through the primary side winding 111. The switching device 120 is a power MOSFET, for example. The resistance 130 is provided between the switching device 120 and a reference potential. The resistance 130 adjusts a magnitude of the main current.

The control chip 100 controls ON and OFF states of the switching device 120. The control chip 100 may output a control signal OUT to be input to a gate terminal of the switching device 120. The control chip is an integrated circuit chip, for example. An OUT terminal from which the control signal OUT is output in the control chip 100 of the present example is set as a third terminal 103. A GND terminal to which a reference potential GND is applied in the control chip 100 is set as a second terminal 102, and a VCC terminal to which a power source voltage VCC is applied is set as a first terminal 101.

When the switching device 120 is put into the ON state and an excitation current flows through the primary side winding 111, a load current according to a turn ratio flows through the secondary side winding 112. The load current flowing through the secondary side winding 112 is rectified by the diode 160. The capacitor 162 is charged with an output of the diode 160. The load is applied with an output voltage Vout according to an amount of charges accumulated in the capacitor 162.

The auxiliary winding 113 supplies the power supply electric power to the first terminal 101. The auxiliary winding 113 of the present example is arranged between the first terminal 101 of the control chip 100 and the reference potential. The auxiliary winding 113 is magnetically coupled to the secondary side winding 112. That is, a current according to the current of the secondary side winding 112 flows through the auxiliary winding 113. The second resistor element 122 and the diode 128 may be arranged between the auxiliary winding 113 and the first terminal 101. The diode 128 rectifies the current flowing through the auxiliary winding 113. The second resistor element 122 is arranged between the diode 128 and the first terminal 101. The first capacitor 131 and the second capacitor 135 are charged with the current that has passed through the diode 128.

The first capacitor 131 is electrically connected to the first terminal 101 of the control chip 100. The first capacitor 131 of the present example is directly connected to the first terminal 101 of the control chip 100 without an intermediation of another element. The second capacitor 135 is electrically connected to the first terminal 101 of the control chip 100. The electrical power accumulated in the first capacitor 131 is supplied as the power supply electric power of the control chip 100. The first capacitor 131 of the present example is an electrolytic capacitor. A capacity of the first capacitor 131 may be larger than a capacity of the second capacitor 135. The capacity of the first capacitor 131 may be similarly larger than a capacity of the capacitor 134 or the capacitor 136. By providing the second capacitor 135, noise of the electrical power supplied to the first terminal 101 is absorbed.

The control chip 100 may include a CS terminal which senses a magnitude of the main current (drain current in the present example) flowing through the switching device 120. The CS terminal takes in a potential representing a magnitude of a voltage drop in the resistance 130. Since the voltage drop according to the magnitude of the main current occurs in the resistance 130, the magnitude of the main current can be sensed from the potential. The CS terminal of the present example takes in a potential at an end of the resistance 130 connected to the switching device 120. A filter constituted by the resistance 132 and the capacitor 134 may be provided between the CS terminal and the resistance 130. The control chip 100 may control the switching device 120 to be put into the OFF state when an overcurrent flows through the switching device 120.

The control chip 100 may include an FB terminal to which a signal representing a magnitude of the output voltage Vout of the secondary side circuit 220 is input. The light emitting device 164, the resistance 166, and the diode 168 in the secondary side circuit 220 are provided in series between a terminal from which the output voltage Vout is output and the reference potential. A current according to the magnitude of the output voltage Vout flows through the light emitting device 164 to output light with an intensity according to the magnitude of the current. The light emitting device 164 is a light emitting diode, for example.

The light receiving device 170 receives light output by the light emitting device 164. The light receiving device 170 is a phototransistor, for example. The light receiving device 170 inputs a current according to an intensity of the received light to the FB terminal. With this configuration, the current according to the output voltage Vout flows through the FB terminal. The primary side circuit 210 may include the capacitor 136 provided in parallel with the light receiving device 170. With this configuration, it is possible to remove a high frequency component of the current flowing through the FB terminal.

A voltage at the FB terminal varies according to the output voltage Vout. The control chip 100 controls a period in which the switching device 120 is turned on and a period in which the switching device 120 is turned off according to the voltage of the FB terminal. As an example, as the output voltage Vout is higher, the control chip 100 further shortens a period in which the switching device 120 is turned on in each switching cycle.

The control chip 100 includes a VH terminal from which a charging current is supplied to the VCC terminal when the switched-mode power supply 300 is activated. With this configuration, the first capacitor 131 connected to the VCC terminal is charged. When a voltage of the first capacitor 131 increases to start the switching control by the control chip 100, the supply of the charging current from the VH terminal stops. With this configuration, while the activation of the control chip 100 can be sped up, it is possible to reduce power consumption. The VH terminal of the present example is connected to the power supply circuit 230 via the diode 150, the diode 152, and the resistance 140.

The control chip 100 may include an RT terminal which detects a temperature of the switched-mode power supply 300. A temperature detection device such as the thermistor 138 may be connected to the RT terminal.

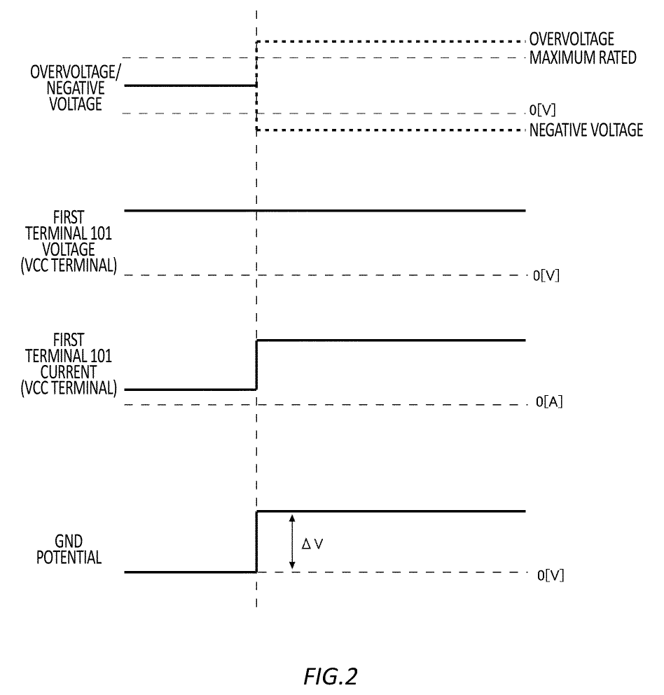

FIG. 2 is a diagram for describing an operation example of the control chip 100. In the present example, a case will be described where an overvoltage or a negative voltage is applied to any terminal other than the first terminal 101 (VCC terminal) and the second terminal 102 (GND terminal) in the control chip 100. The above-described terminal is the third terminal 103 (OUT terminal), for example, but is not limited to this. The overvoltage is a voltage larger than a maximum rated of the control chip 100, and the negative voltage is a voltage less than 0 V. The maximum rated is a maximum voltage with which the terminal of the control chip 100 is not disrupted by the voltage. The overvoltage or the negative voltage may be generated due to a lightning surge or the like, for example. In the present specification, the overvoltage or the negative voltage may be referred to as a surge voltage or a surge.

The control chip 100 includes a circuit such as a CMOS formed on a semiconductor substrate. When the control chip 100 is applied with the surge voltage, a parasitic element formed on the semiconductor substrate may operate, and an unexpected current may flow in the semiconductor substrate to disrupt the control chip 100. For example, when the semiconductor substrate is applied with the surge voltage to cause the parasitic element to operate and the power source voltage VCC applied to the first terminal 101 is maintained, a current flows from the first terminal 101 to the semiconductor substrate. With this configuration, a GND potential of the semiconductor substrate instantaneously increases (+ΔV). When the GND potential increases, another parasitic element present in the semiconductor substrate operates, and an unexpected current flows through an element with a low breakdown voltage in the semiconductor substrate, so that the element is disrupted. A case is also conceivable where an anode potential of a protection element or a parasitic diode of the control chip 100 falls, and break down occurs to cause thermal disruption.

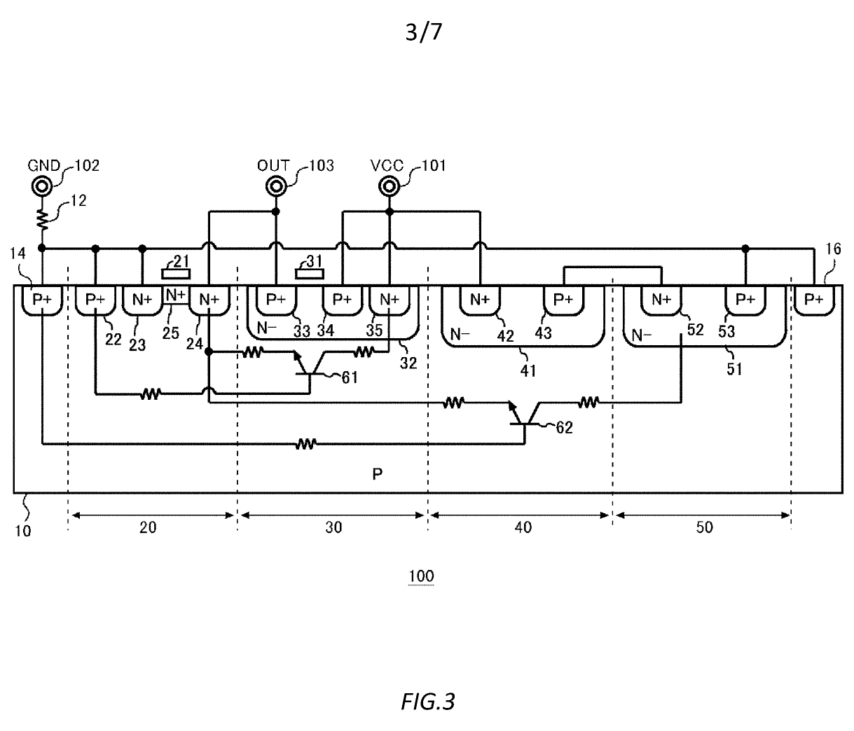

FIG. 3 is a cross sectional view of a semiconductor substrate 10 in the control chip 100. The semiconductor substrate 10 is a silicon substrate, for example, but may be a compound semiconductor substrate such as an SiC substrate. The semiconductor substrate 10 illustrated in FIG. 3 is a P type substrate but may be an N type substrate.

The semiconductor substrate 10 of the present example is provided with an element 20, an element 30, an element 40, and an element 50. The element 20 of the present example is an N channel MOSFET formed in a P type region of the semiconductor substrate 10, and the element 30 is a P channel MOSFET formed in an N- type well region 32 of the semiconductor substrate 10. The element 20 and the element 30 constitute a CMOSFET.

The element 40 is formed in an N- type well region 41, and the element 50 is formed in an N- type well region 51. The element 40 and the element 50 are protection elements provided between the first terminal 101 and the second terminal 102 in series. The element 40 and the element 50 cause a current to flow through the second terminal 102 from the first terminal 101 when the power source voltage VCC of the first terminal 101 exceeds an upper limit voltage. With this configuration, the element 20 and the element 30 are protected. The element 40 and the element 50 of the present example are diodes, and the upper limit voltage is set by a reverse breakdown voltage of each diode.

The element 20 includes an N+ type source region 23, an N+ type drain region 24, a P+ type contact region 22, and a gate electrode 21. The contact region 22 and the source region 23 are electrically connected to the second terminal 102. A resistance 12 in FIG. 3 represents a parasitic resistance component between the second terminal 102 and the semiconductor substrate 10. The drain region 24 is electrically connected to the third terminal 103. The gate electrode 21 is arranged to face a channel region 25 between the source region 23 and the drain region 24. A gate insulating film is provided between the gate electrode 21 and the channel region 25. When the gate electrode 21 is applied with a predetermined ON-state voltage, the channel region 25 is inverted into a region of an N+ type, and the source region 23 and the drain region 24 establish conduction. In FIG. 3, the channel region 25 represents a state of being inverted to the N+ type.

The element 30 includes a P+ type drain region 33, a P+ type source region 34, an N+ type contact region 35, and a gate electrode 31. A contact region 35 and a source region 34 are electrically connected to the first terminal 101. The drain region 33 is electrically connected to the third terminal 103. The gate electrode 31 is arranged to face a channel region of an N- type between the source region 34 and the drain region 33. When the gate electrode 31 is applied with a predetermined ON-state voltage, the channel region is inverted into a region of a P+ type, and the source region 34 and the drain region 33 establish conduction.

The element 40 includes an N+ type cathode region 42 and a P+ type anode region 43. The element 40 of the present example is a PN junction diode. The cathode region 42 is electrically connected to the first terminal 101. The anode region 43 is electrically connected to a cathode region 52 of the element 50. The well region 41 may be provided between the cathode region 42 and the anode region 43.

The element 50 includes the N+ type cathode region 52 and a P+ type anode region 53. The element 50 of the present example is a PN junction diode. The cathode region 52 is electrically connected to the anode region 43 of the element 40. The anode region 53 is electrically connected to the second terminal 102. The well region 51 may be provided between the cathode region 52 and the anode region 53.

The semiconductor substrate 10 of the present example is provided with a P+ type contact region 14 and a P+ type contact region 16. The contact region 14 and the contact region 16 are electrically connected to the second terminal 102. The contact region 14 and the contact region 16 may be a part of the element different from the element 20 to the element 50.

In the semiconductor substrate 10, a large number of parasitic elements exist. In the example of FIG. 3, a first parasitic transistor 61 and a second parasitic transistor 62 are illustrated. The semiconductor substrate 10 also includes a first connecting region electrically connected to the first terminal 101 and a second connecting region electrically connected to the second terminal 102. In the example of FIG. 3, the source region 34, the contact region 35, and the cathode region 42 fall into the first connecting region. The contact region 14, the contact region 22, the source region 23, the anode region 53, and the contact region 16 fall into the second connecting region.

The first parasitic transistor 61 is connected to the first connecting region (the contact region 35 in the present example). The first parasitic transistor 61 of the present example is an npn transistor in which the contact region 35 functions as a collector region, the drain region 24 functions as an emitter region, and a body of the semiconductor substrate 10 functions as a base region. The first terminal 101 of the present example is connected to the second terminal 102 via the first parasitic transistor 61.

The second parasitic transistor 62 causes a current to flow through the protection element (the element 50 in the present example) according to a potential of the second connecting region (the contact region 14 in the present example). The second parasitic transistor 62 of the present example is an npn transistor in which the well region 51 functions as a collector region, the drain region 24 functions as an emitter region, the contact region 14 (or the body of the semiconductor substrate 10) functions as a base region.

A case will be described where any of terminals of the control chip 100 is applied with a negative voltage due to the lightning surge. The terminal of the present example is the third terminal 103. When the third terminal 103 is applied with the negative voltage, a potential difference is generated between the base and the emitter of the first parasitic transistor 61 to put the first parasitic transistor 61 into the ON state. With this configuration, as described in FIG. 2, the current flows from the first terminal 101 to the second terminal 102. Specifically, the current flows from the first terminal 101 to the second terminal 102 via the contact region 35, the well region 32, the body of the semiconductor substrate 10, the drain region 24, the channel region 25, the source region 23, and the resistance 12.

When the current flows from the first terminal 101 to the second terminal 102, as described in FIG. 2, the GND potential of the contact region 14 rises according to a voltage drop amount ΔV in the resistance 12. With such an operation, since the GND potential in the second connecting region rises, the parasitic element of the semiconductor substrate 10 may operate.

When the potential of the contact region 14 rises, a potential difference is generated between the base and the emitter in the second parasitic transistor 62 to put the second parasitic transistor 62 into the ON state. With this configuration, a current flows from the well region 51 of the protection element 50 to the second terminal 102. Specifically, the current flows from the element 50 to the second terminal 102 via the body of the semiconductor substrate 10, the drain region 24, the channel region 25, the source region 23, and the resistance 12. With this configuration, potentials of the well region 51 and the cathode region 52 fall. Since the element 40 is directly connected to the VCC terminal, the potentials of the well region 41 and the cathode region 42 of the element 40 are fixed to the potential of the VCC terminal. On the other hand, the well region 51 and the cathode region 52 of the element 50 are connected to the anode region 43 of the element 40. Thus, potentials of the well region 51 and the cathode region 52 are less stable than those of the well region 41 and the cathode region 42. When the second parasitic transistor 62 operates, a potential fall is likely to occur in the well region 51 and the cathode region 52 where the potential is unstable.

In accordance with the potential fall of the cathode region 52, the potential of the anode region 43 of the element 40 also falls. Thus, the element 40 breaks down. When the element 40 which has broken down suffers thermal disruption, the element 40 is put into a short circuit state. When the element 40 is put into the short circuit state, the element 50 also breaks down to suffer thermal disruption.

The semiconductor substrate 10 in FIG. 3 is provided with a protection element constituted by diodes (the element 40 and the element 50) in two stages which are connected in series. In another example, the protection element may be constituted by diodes in more stages. For example, the protection element may have diodes in five stages which are connected in series.

More specifically, a diode in one or more stages (for example, three stages) may be inserted in series between the element 40 and the element 50. When the protection element is constituted by multistage diodes, to secure the breakdown voltage, the well region 41 and the well region 51 are preferably separated from each other by a P type region. A diode in one or more stages (for example, three stages) is formed between the well region 41 and the well region 51.

In this case too, the well region 41 and the cathode region 52 of the element 40 are connected to the VCC terminal. Thus, the potentials of the well region 41 and the cathode region 42 are fixed to the potential of the VCC terminal. On the other hand, the well region 51 and the cathode region 52 of the element 50 are connected to the VCC potential such as the well region 41 via the anode region 43 of the element 40 and the diode in one or more stages (for example, three stages). Thus, the potential of the well region 51 of the element 50 becomes still more unstable than the example of FIG. 3, and the potential drop is more likely to occur. As a result, each diode (for example, the element 40 or the like) on a side with a potential higher than that of the element 50 breaks down to suffer thermal disruption. Similarly as in the example of FIG. 3, when the element 40 or the like is put into the short circuit state, the element 50 also breaks down to suffer thermal disruption.

In the present example, the case has been described where the third terminal 103 is applied with the negative voltage. However, when any of the terminals is applied with an overvoltage or a negative voltage, the GND potential of the second connecting region may rise due to an operation similar to that of the first parasitic transistor 61. When the GND potential of the second connecting region rises, an unexpected current may flow through any element due to an operation similar to that of the second parasitic transistor 62. Thus, in the switched-mode power supply 300 described in FIG. 1 to FIG. 3, a withstand capability of the control chip 100 against the lightning surge or the like is not sufficient.

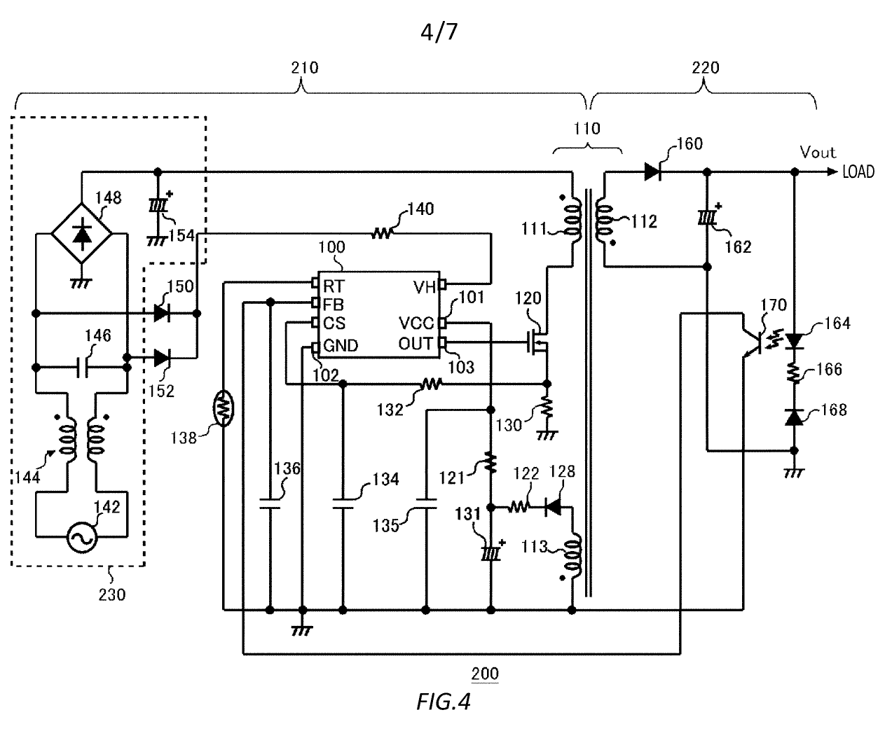

FIG. 4 illustrates a configuration example of a switched-mode power supply 200 according to an embodiment of the present invention. The switched-mode power supply 200 of the present example includes a first resistor element 121 in addition to the components of the switched-mode power supply 300 described in FIG. 1 to FIG. 3. The components other than the first resistor element 121 are similar to those of the switched-mode power supply 300.

The first resistor element 121 is electrically connected to the first terminal 101 of the control chip 100. More specifically, the first resistor element 121 is arranged between the first connecting region (for example, any of the source region 34, the contact region 35, and the cathode region 42) described in FIG. 3 and the first capacitor 131. The first resistor element 121 is not a parasitic resistance component such as a wiring but is a resistor element that has been intentionally inserted. A resistance value of the first resistor element 121 is greater than that of a parasitic resistance component in a wiring from the first terminal 101 to the first capacitor 131.

When the first resistor element 121 is provided, a current flowing through the first parasitic transistor 61 can be reduced. With this configuration, an increase of the GND potential in the second connecting region can be suppressed or avoided. Thus, a flow of an unexpected current through an element provided in the semiconductor substrate 10 is suppressed, and thermal disruption of the protection element can be suppressed.

The first terminal 101 of the present example is a power source terminal VCC to which the power supply electric power is supplied. A current greater than that of another terminal is supplied to the power source terminal VCC. Thus, when the control chip 100 is applied with the surge voltage, the first parasitic transistor 61 connected to the power source terminal VCC causes a large current to flow, so that the GND potential significantly rises. When the power source terminal VCC is provided with the first resistor element 121, the current flowing from the power source terminal VCC to the first parasitic transistor 61 can be suppressed to effectively suppress the rise of the GND potential.

The first terminal 101 may be a terminal other than the power source terminal VCC. Even in a case of the terminal other than the power source terminal VCC, when a capacity of the first capacitor 131 connected to the first terminal 101 is large, the parasitic element connected to the first terminal 101 causes a large current to flow in a case where the control chip 100 is applied with the surge voltage. A capacity value of the first capacitor 131 connected to the first terminal 101 may be greater than or equal to 5 μF and less than or equal to 100 μF. As illustrated in FIG. 4, the first terminal 101 may be the power source terminal VCC, and the capacity value of the first capacitor 131 may be greater than or equal to 5 μF and less than or equal to 100 μF. The capacity value of the first capacitor 131 may be greater than or equal to 10 μF or may be greater than or equal to 20 μF.

The first resistor element 121 may be arranged between the first capacitor 131 and the first terminal 101 and between the second capacitor 135 and the first terminal 101. When a capacity of the second capacitor 135 is relatively large, the first resistor element 121 is preferably arranged between the first capacitor 131 and the second capacitor 135, and the first terminal 101. A capacity value of the second capacitor 135 of the present example is greater than or equal to 50 nF and less than or equal to 1000 nF. As in this case, when the capacity value of the second capacitor 135 is small, as illustrated in FIG. 4, the second capacitor 135 may be connected to a wiring between the first resistor element 121 and the first terminal 101. When the second capacitor 135 with the small capacity is provided, a surge generated in the auxiliary winding 113 or the like can be absorbed.

The resistance value of the first resistor element 121 may be greater than or equal to 10 Ω and less than or equal to 100 Ω. When the resistance value of the first resistor element 121 is set to be greater than or equal to 10 Ω, the current flowing through the first parasitic transistor 61 can be effectively suppressed. The resistance value of the first resistor element 121 may be greater than or equal to 20 Ω, may be greater than or equal to 30 Ω, or may be greater than or equal to 50 Ω. When the resistance value of the first resistor element 121 is set to be less than or equal to 100 Ω, the increase in the power consumption due to the provision of the first resistor element 121 can be suppressed.

The first resistor element 121 of the present example is arranged between the first terminal 101 and the first capacitor 131 outside the control chip 100. With this configuration, the first resistor element 121 can be easily provided. In another example, the first resistor element 121 may be arranged between the first terminal 101 and the first connecting region inside the control chip 100. With this configuration, the withstand capability of the switched-mode power supply 200 can be improved without alterations of the circuit configuration other than the control chip 100.

The second resistor element 122 is arranged between the auxiliary winding 113 and the first capacitor 131. When the second resistor element 122 is provided, a circuit in a subsequent stage can be protected from the surge generated in the auxiliary winding 113. The second resistor element 122 of the present example is arranged between the auxiliary winding 113, and the first capacitor 131 and the first terminal 101. A resistance value of the second resistor element 122 may be greater than or equal to 10 Ω and less than or equal to 100 Ω. The resistance value of the first resistor element 121 may be greater than, may be the same as, or may be less than, the resistance value of the second resistor element 122.

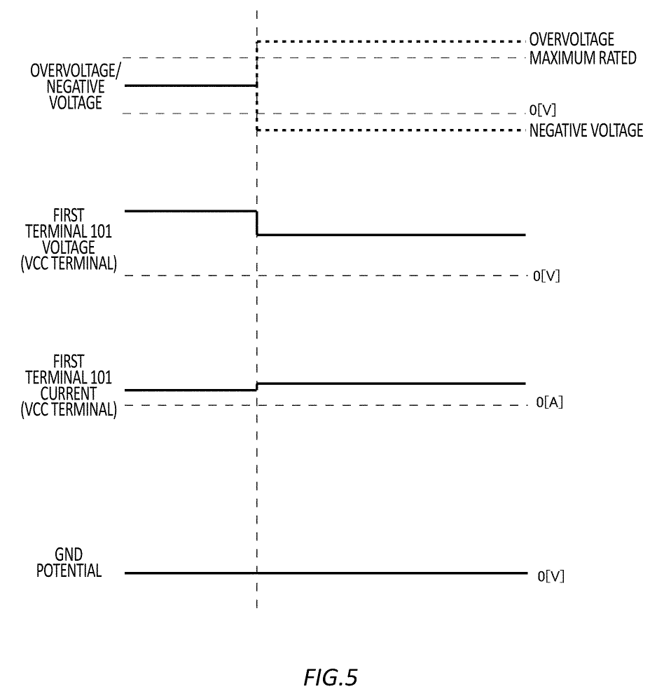

FIG. 5 is a diagram for describing an operation example of the control chip 100 illustrated in FIG. 4. As described above, the first resistor element 121 is connected to the first terminal 101 of the control chip 100. With this configuration, it is possible to suppress the current flowing through the first parasitic transistor 61 from the first terminal 101 when any of the terminals of the control chip 100 is applied with the overvoltage or the negative voltage. The voltage at the first terminal 101 is further reduced according to the voltage drop in the first resistor element 121.

Since the current flowing through the first parasitic transistor 61 is suppressed, the rise of the GND potential can be suppressed or avoided. With this configuration, such a state can be suppressed that the second parasitic transistor 62 is put into the ON state, and the withstand capability against the lightning surge or the like can be improved.

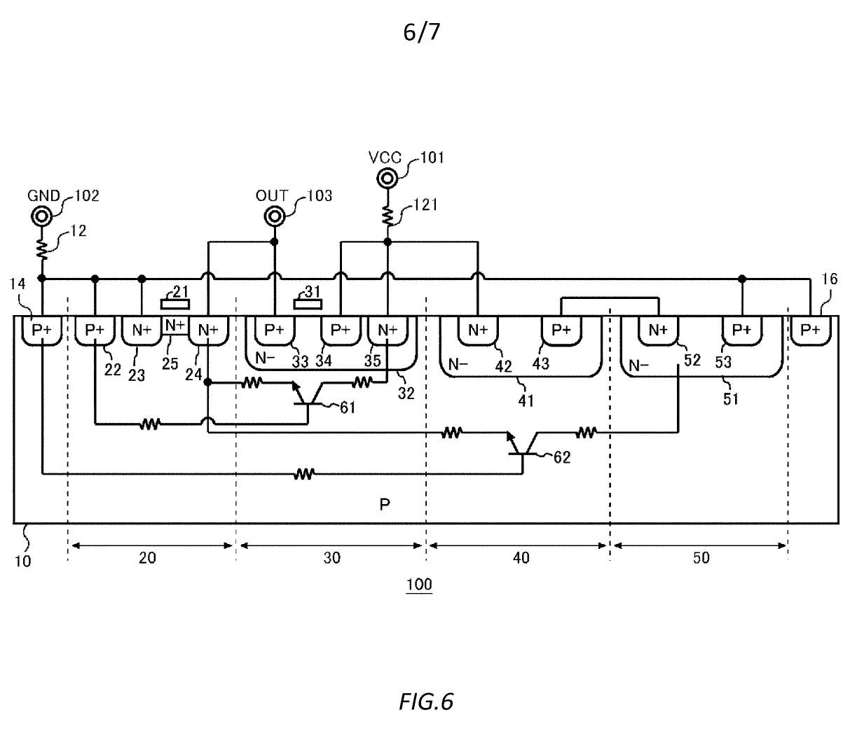

FIG. 6 is a cross sectional view of the semiconductor substrate 10 in the control chip 100 according to a modified example. In the present example, the first resistor element 121 is provided between the first terminal 101 and the first connecting region (for example, any of the source region 34, the contact region 35, and the cathode region 42). A structure other than the first resistor element 121 is similar to the example of FIG. 3.

The first resistor element 121 may be a polysilicon resistance formed on the semiconductor substrate 10. When the first resistor element 121 is provided inside the control chip 100, a configuration may be adopted where the first resistor element 121 outside the control chip 100 as illustrated in FIG. 4 is not provided. Alternatively, the first resistor element 121 may be provided both inside and outside the control chip 100. In this case, a combined resistance value of the two first resistor elements 121 may be greater than or equal to 10 Ω or less than or equal to 100 Ω.

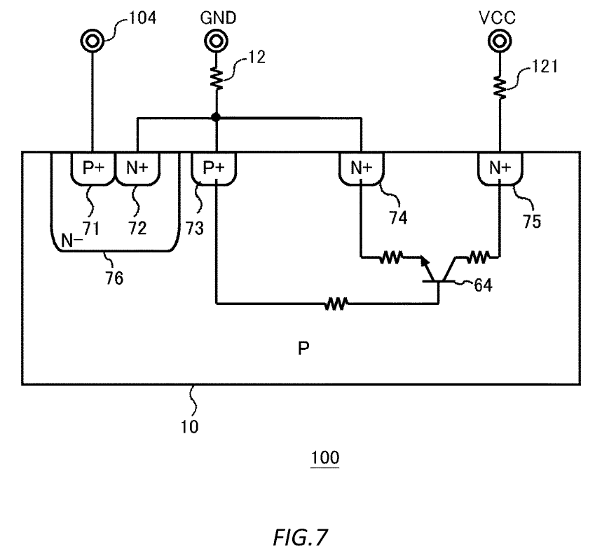

FIG. 7 is a cross sectional view of the semiconductor substrate 10 in the control chip 100 according to the modified example. The semiconductor substrate 10 is not limited to a configuration including the element 20 to the element 50 as described in FIG. 3 or FIG. 6. When any of the terminals of the control chip 100 is applied with a surge overvoltage with high energy, as long as a potential of any region fluctuates since a current flows through the parasitic element connected to any terminal, the withstand capability against the surge voltage can be improved by providing the first resistor element 121.

The control chip 100 of the present example includes a fourth terminal 104. The semiconductor substrate 10 is provided with a P+ type region 71, an N+ type region 72, a P+ type region 73, an N+ type region 74, an N+ type region 75, and an N- type region 76. The region 71, the region 72, and the region 76 are a PN junction diode which functions as the protection element, for example, but the configuration is not limited to this. The region 73, the region 74, and the region 75 may be regions provided to any element. The region 73, the region 74, and the region 75 may be regions of a transistor, may be regions of a diode, or may be a region of another element. The region 73, the region 74, and the region 75 function as a parasitic transistor 64 of an npn type.

When the fourth terminal 104 connected to the region 71 is applied with the overvoltage surge voltage, a current flows from the fourth terminal 104 to the GND terminal. Specifically, the current flows from the fourth terminal 104 to the GND terminal via the region 71, the region 72, and the resistance 12. With this configuration, the GND potential of the region 73 rises. When the GND potential of the region 73 rises, the parasitic transistor 64 is put into the ON state, and a current flows from the region 75 to the region 74. When the region 75 is a part of the protection element similar to the element 40 illustrated in FIG. 3, break down occurs similarly as in the element 40. In response to this, by providing the first resistor element 121, the rise of the GND potential of the region 73 can be suppressed. The first resistor element 121 of the present example may be connected to the fourth terminal 104. As illustrated in FIG. 7, the VCC terminal may be provided with the first resistor element 121. The first resistor element 121 may be provided inside the control chip 100 as illustrated in FIG. 7 or may be provided outside the control chip 100 similarly as in the example of FIG. 4.

While the present invention has been described above by way of the embodiments, the technical scope of the present invention is not limited to the above-described embodiments. It is apparent to persons skilled in the art that various alterations or improvements can be made to the above-described embodiments. It is also apparent from description of the claims that the embodiments to which such modifications or improvements are made may be included in the technical scope of the present invention.

What is claimed is:

1. A switched-mode power supply comprising: a main transformer;
a switching device which performs switching control of a main current flowing through the main transformer;
a control chip which includes a first terminal and controls the switching device; a first capacitor connected to the first terminal of the control chip; and
a first resistor element connected to the first terminal, wherein the control chip includes a semiconductor substrate including a first connecting region connected to the first terminal, the first resistor element is arranged between the first connecting region and the first capacitor, and
the first terminal is a power supply terminal to which power supply electric power is supplied.

2. A switched-mode power supply comprising:
a main transformer;
a switching device which performs switching control of a main current flowing through the main transformer;
a control chip which includes a first terminal and controls the switching device;
a first capacitor which is connected to the first terminal of the control chip and a capacity value of which is greater than or equal to 5 μF and less than or equal to 100 μF; and
a first resistor element connected to the first terminal, wherein
the control chip includes a semiconductor substrate including a first connecting region connected to the first terminal, and
the first resistor element is arranged between the first connecting region and the first capacitor.

3. The switched-mode power supply according to claim 2, wherein
the first terminal is a power supply terminal to which power supply electric power is supplied.

4. The switched-mode power supply according to claim 1, wherein
the first resistor element is arranged between the first terminal and the first capacitor outside the control chip.

5. The switched-mode power supply according to claim 1, wherein
the first resistor element is arranged between the first terminal and the first connecting region inside the control chip.

6. The switched-mode power supply according to claim 1, wherein
a resistance value of the first resistor element is greater than or equal to 10 Ω and less than or equal to 100 Ω.

7. The switched-mode power supply according to claim 1, further comprising:
an auxiliary winding which supplies the power supply electric power to the first terminal; and
a second resistor element which is arranged between the auxiliary winding and the first capacitor and a resistance value of which is greater than or equal to 10 Ω and less than or equal to 100 Ω.

8. The switched-mode power supply according to claim 4, further comprising:
a second capacitor which is connected between the first resistor element and the first terminal and a capacity value of which is greater than or equal to 50 nF and less than or equal to 1000 nF.

9. The switched-mode power supply according to claim 1, wherein
the semiconductor substrate includes a first parasitic transistor connected to the first connecting region,
the control chip includes a second terminal to which a reference potential is applied, and
the first terminal is connected to the second terminal via the first parasitic transistor.

10. The switched-mode power supply according to claim 9, wherein
the semiconductor substrate includes a protection element which is provided between the first terminal and the second terminal and causes a current to flow from the first terminal to the second terminal when a voltage at the first terminal exceeds an upper limit voltage,
a second connecting region connected to the second terminal, and a second parasitic transistor which causes a current to flow through the protection element according to a potential of the second connecting region.

11. The switched-mode power supply according to claim 2, wherein
the first resistor element is arranged between the first terminal and the first capacitor outside the control chip.

12. The switched-mode power supply according to claim 2, wherein
the first resistor element is arranged between the first terminal and the first connecting region inside the control chip.

13. The switched-mode power supply according to claim 2, wherein
a resistance value of the first resistor element is greater than or equal to 10 Ω and less than or equal to 100 Ω.

14. The switched-mode power supply according to claim 2, further comprising:
an auxiliary winding which supplies the power supply electric power to the first terminal; and
a second resistor element which is arranged between the auxiliary winding and the first capacitor and a resistance value of which is greater than or equal to 10 Ω and less than or equal to 100 Ω.

15. The switched-mode power supply according to claim 11, further comprising:
a second capacitor which is connected between the first resistor element and the first terminal and a capacity value of which is greater than or equal to 50 nF and less than or equal to 1000 nF.

16. The switched-mode power supply according to claim 2, wherein
the semiconductor substrate includes a first parasitic transistor connected to the first connecting region,
the control chip includes a second terminal to which a reference potential is applied, and
the first terminal is connected to the second terminal via the first parasitic transistor.

17. The switched-mode power supply according to claim 16, wherein
the semiconductor substrate includes
a protection element which is provided between the first terminal and the second terminal and causes a current to flow from the first terminal to the second terminal when a voltage at the first terminal exceeds an upper limit voltage,
a second connecting region connected to the second terminal, and
a second parasitic transistor which causes a current to flow through the protection element according to a potential of the second connecting region.

18. The switched-mode power supply according to claim 3, wherein
the first resistor element is arranged between the first terminal and the first capacitor outside the control chip.

19. The switched-mode power supply according to claim 3, wherein
the first resistor element is arranged between the first terminal and the first connecting region inside the control chip.

20. The switched-mode power supply according to claim 3, wherein
a resistance value of the first resistor element is greater than or equal to 10 Ω and less than or equal to 100 Ω.
